(19) United States
(12) Patent Application Publication
(10) Pub. No.: US 2026/0292197 A1
(43) Pub. Date: Sep. 24, 2026

(54) A CODING METHOD OR APPARATUS BASED ON CAMERA MOTION INFORMATION

(71) Applicant: InterDigital CE Patent Holdings, SAS, Paris (FR)

(72) Inventors: Sylvain THIEBAUD, NOYAL SUR VILAINE (FR); Guillaume BOISSON, PLEUMELEUC (FR); Tangi POIRIER, THORIGNE-FOUILLARD (FR)

(21) Appl. No.: 19/469,871

(22) PCT Filed: Mar. 26, 2024
(86) PCT No.: PCT/EP2024/058153

§ 371 Date: Sep. 26, 2025

(30) Foreign Application Priority Data
Mar. 28, 2023 (EP) 23305419.6

(51) Int. Cl. H04N 19/139; A63F 13/52; H04N 19/147; H04N 19/176

(52) U.S. Cl. CPC H04N 19/139; A63F 13/52; H04N 19/147; H04N 19/176

(57) ABSTRACT

At least a method and an apparatus are presented for efficiently encoding or decoding video. For example, motion information is determined that is representative of camera motion between a current image and a reference image, where the current image and the reference image are part of a game engine 2D rendered video. For instance, motion information is determined for at least one sample in the coding block of the current image coded in inter with respect to a reference image from a depth model for the coding block and the camera parameters. For instance, at least one parameter of a depth model for the coding block is obtained from alternative motion vector and a depth model includes a plane representative of depth values. The camera motion information is utilized in the encoding or decoding of the block.

### CROSS REFERENCE TO RELATED APPLICATIONS

This application claims the benefit of European Patent Application No. 2023P00218WO filed on Mar. 28, 2023, which is incorporated herein by reference in its entirety.

### TECHNICAL FIELD

At least one of the present embodiments generally relates to a method or an apparatus for video encoding or decoding, and more particularly, to a method or an apparatus comprising determining motion information representative of camera motion.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

To obtain coding gains, modern codec standards define more and more sophisticated tools, and let the codec encoder decide the best ones to use. In the scope of cloud gaming compression, minimizing the latency is key. Although intensive computation capabilities are required in recent encoders that introduce a latency between the rendering of the game content and its coding.

Existing methods for coding and decoding show some limitations in the domain of coding 2D rendered video of a game engine. Therefore, there is a need to improve the state of the art.

### SUMMARY

The drawbacks and disadvantages of the prior art are solved and addressed by the general aspects described herein.

According to a first aspect, there is provided a method. The method comprises obtaining a position of a current sample in a current image; determining a position of a reference sample in a reference image using a motion vector for the current sample and the position of the current sample in the current image; determining a 3D point position corresponding to the current sample in the current image based on the position of the current sample in the current image and in the reference image and based on camera parameters for the current image and for the reference image; determining a depth value of the current sample in the current image, wherein the depth value is used as at least one depth parameter of a depth model, the depth model including a plane representative of depth values of at least one sample in the current image; and the depth model being used to determine motion information representative of camera motion between the current image and the reference image.

According to a second aspect, there is provided a method. The method comprises video encoding by obtaining a coding block in a current image, where the current image is part of a game engine 2D rendered video; obtaining at least one parameter of a depth model according to the first aspect, where the depth model for the coding block includes a plane representative of depth values; obtaining camera parameters for the current image and for the reference image; determining motion information for at least one sample in the coding block of the current image to be coded in inter with respect to a reference image, where motion information is determined from the depth model for the coding block and the camera parameters, where motion information is representative of camera motion between the current image and the reference image; and encoding the coding block based on the motion information.

According to third aspect, there is provided a method. The method comprises video decoding by obtaining a coding block in a current image, where the current image is part of a game engine 2D rendered video; obtaining at least one parameter of a depth model according to the first aspect, where the depth model for coding block includes a plane representative of depth values; obtaining camera parameters for the current image and for the reference image; determining motion information for at least one sample in the coding block of the current image coded in inter with respect to a reference image, where motion information is determined from the depth model for the coding block and the camera parameters, and where motion information is representative of camera motion between the current image and the reference image; and decoding the coding block based on the motion information.

According to another aspect, there is provided an apparatus. The apparatus comprises one or more processors, wherein the one or more processors are configured to implement the method for video encoding according to any of its variants. According to another aspect, the apparatus for video encoding comprises means for implementing the method for video decoding according to any of its variants.

According to another aspect, there is provided another apparatus. The apparatus comprises one or more processors, wherein the one or more processors are configured to implement the method for video decoding according to any of its variants. According to another aspect, the apparatus for video decoding comprises means for implementing the method for video decoding according to any of its variants.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates a block diagram of an example apparatus in which various aspects of the embodiments may be implemented.

FIG. 2 illustrates a block diagram of an embodiment of video encoder in which various aspects of the embodiments may be implemented.

FIG. 3 illustrates a block diagram of an embodiment of video decoder in which various aspects of the embodiments may be implemented.

FIG. 4 illustrates an example texture frame of a video game with a corresponding depth map.

FIG. 5 illustrates an example architecture of a cloud gaming system.

FIG. 6 illustrates a camera motion inter tool in a codec in which various aspects of the embodiments may be implemented.

FIG. 7 illustrates 4 exemplary representations of a plane of a depth model according to at least one embodiment.

FIG. 8 illustrates principles of a pinhole camera model of a virtual camera in a cloud gaming system.

FIG. 9 illustrates projection planes of a virtual camera in a cloud gaming system.

FIG. 10 illustrates a generic method according to a general aspect of at least one embodiment.

FIG. 11 illustrates a generic method according to a first variant embodiment with a 2 components motion vector.

FIG. 12 illustrates 2D to 3D transformations according to a first variant embodiment with a 2 components motion vector.

FIG. 13 illustrates a generic method according to a second variant embodiment with a single component motion vector.

FIG. 14 illustrates 2D to 3D transformations according to a second variant embodiment with an horizontal component of the motion vector.

### DETAILED DESCRIPTION

Various embodiments relate to a video coding system in which, in at least one embodiment, it is proposed to adapt video coding tools to the cloud gaming system. Different embodiments are proposed hereafter, introducing some tools modifications to increase coding efficiency and improve the codec consistency when processing 2D rendered game engine video. Amongst others, an encoding method, a decoding method, an encoding apparatus, a decoding apparatus based on this principle are proposed. Although the present embodiments are presented in the context of the cloud gaming system, they may apply to any system where a 2D video may be associated to with camera parameters, such as a video captured by mobile device along with sensor's information allowing to determine the position and characteristics of the device's camera capturing the video. Depth information may be made available either from a sensor or other processing.

Moreover, the present aspects, although describing principles related to particular drafts of VVC (Versatile Video Coding) or to HEVC (High Efficiency Video Coding) specifications, or to ECM (Enhanced Compression Model) reference software are not limited to VVC or HEVC or ECM, and can be applied, for example, to other standards and recommendations, whether pre-existing or future-developed, and extensions of any such standards and recommendations (including VVC and HEVC and ECM). Unless indicated otherwise, or technically precluded, the aspects described in this application can be used individually or in combination.

The acronyms used herein are reflecting the current state of video coding developments and thus should be considered as examples of naming that may be renamed at later stages while still representing the same techniques.

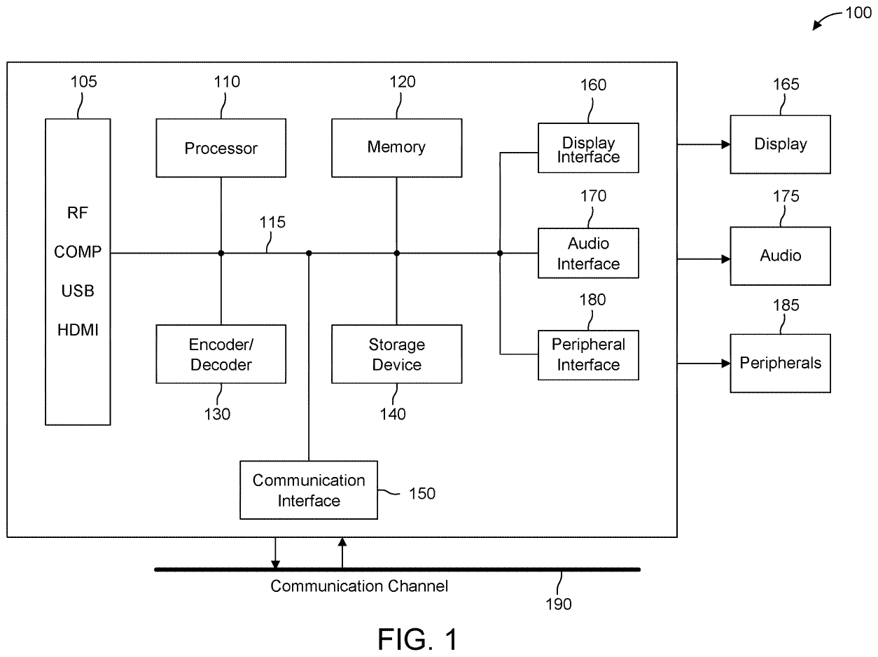

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g. a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules.

Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip. The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

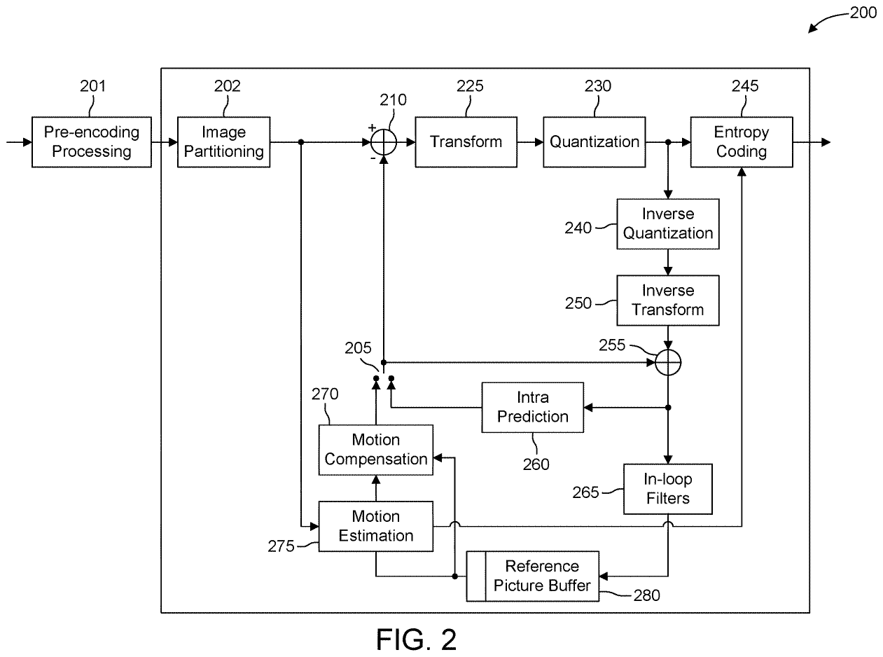

FIG. 2 illustrates an example video encoder 200, such as VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side. Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i. e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

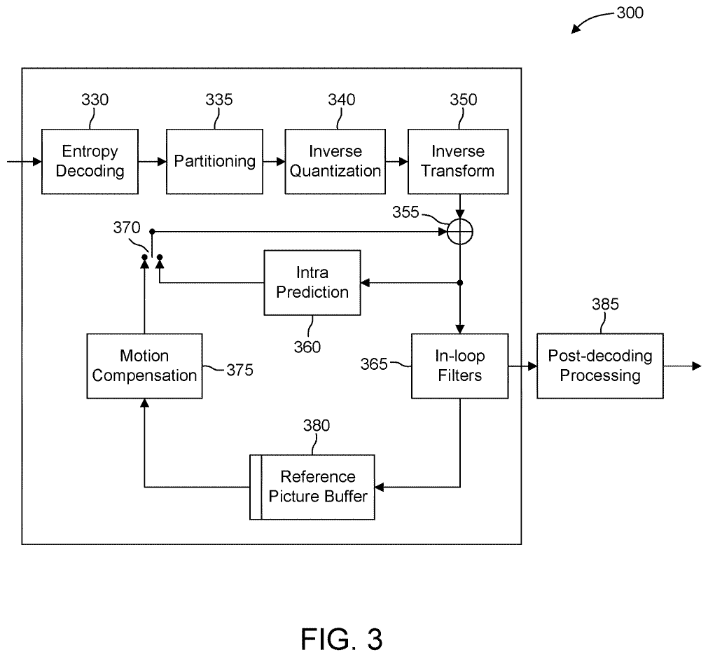

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

A video coding system such as a cloud gaming server or a device with light detection and ranging (LiDAR) capabilities may receive input video frames (e.g., texture frames) together with depth information (e.g., a depth map) and/or motion information, which may be correlated.

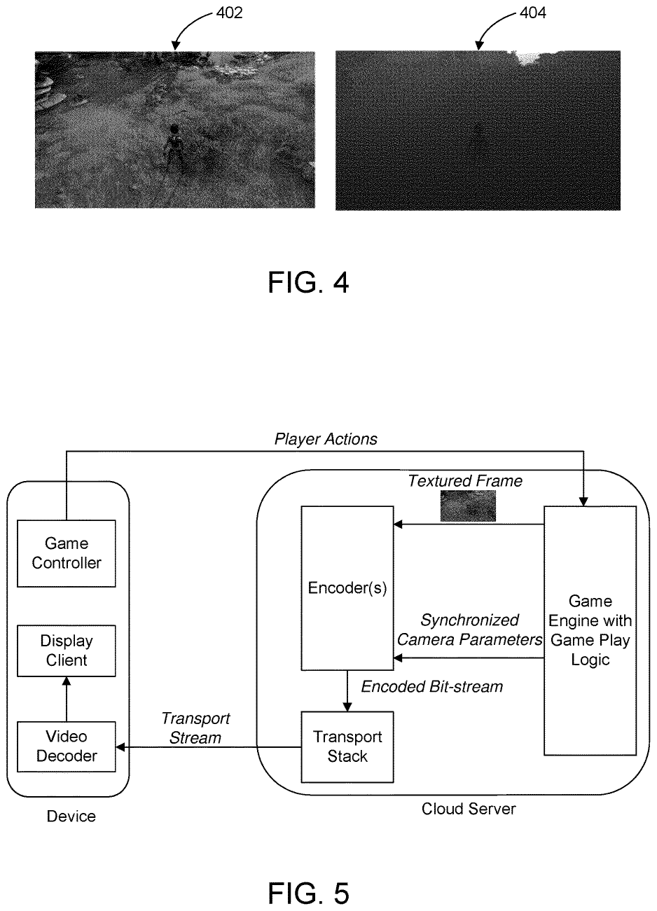

FIG. 4 illustrates an example texture frame 402 of a video game with a corresponding depth map 404 that may be extracted (e.g., directly) from a game engine that is rendering the game scene. A depth map may be provided by the game engine in a floating-point representation.

A depth map may be represented by a grey-level image, which may indicate the distance between a camera and an actual object. A depth map may represent the basic geometry of the captured video scene. A depth map may correspond to a texture picture of a video content and may include a dense monochrome picture of the same resolution as the luma picture. In examples, the depth map and the luma picture may be of different resolutions.

FIG. 5 shows an example architecture of a cloud gaming system, where a game engine may be running on a cloud server. The gaming system may render a game scene based on the player actions. The rendered game scene may be represented as a 2D video including a set of texture frames. The rendered game engine 2D video may be encoded into a bitstream, for example, using a video encoder. The bitstream may be encapsulated by a transport protocol and may be sent as a transport stream to the player's device. The player's device may de-encapsulate and decode the transport stream and present the decoded 2D video representing the game scene to the player. According to various implementations, additional information such as a depth information, motion information, an object ID, an occlusion mask, camera parameters, etc. may be obtained from a game engine (e.g., as outputs of the game engine) and made available to the cloud server (e.g., an encoder of the cloud) as prior information. According to at least one embodiment, a video to encode is generated by 3D game engine as shown in the cloud gaming system of FIG. 5 where the video only includes texture information and synchronized camera parameters. Additional information described herein such as the motion information issued from state of the art motion estimation in the encoder, or camera parameters or a combination thereof may be utilized to perform motion compensation in the rendered game engine 2D video in a video processing device (e.g., the encoder side of a video codec) as for instance described in the EP Application Serial No. 22306847.9 filed on 12 Dec. 2022 by the same applicant which is incorporated herein by reference.

Advantageously, the motion compensation generates inter prediction based on new motion information that is responsive to a new motion model in order to improve coding gains (e.g., compression gains). This new motion model, described in the EP Application Serial No. 22306847.9, may render the motion of a camera in the 3D game engine. The processing based on the camera parameters is referred to as Camera Motion tool or Camera Motion Inter tool in the present disclosure. The Camera Motion tool allows predicting motion in areas of a current image where motion is only affected by the virtual camera of the game engine (its characteristics and position). The present principles address the deriving of depth information to be used Camera Motion Inter tool in both the encoder and the decoder from alternative motion information.

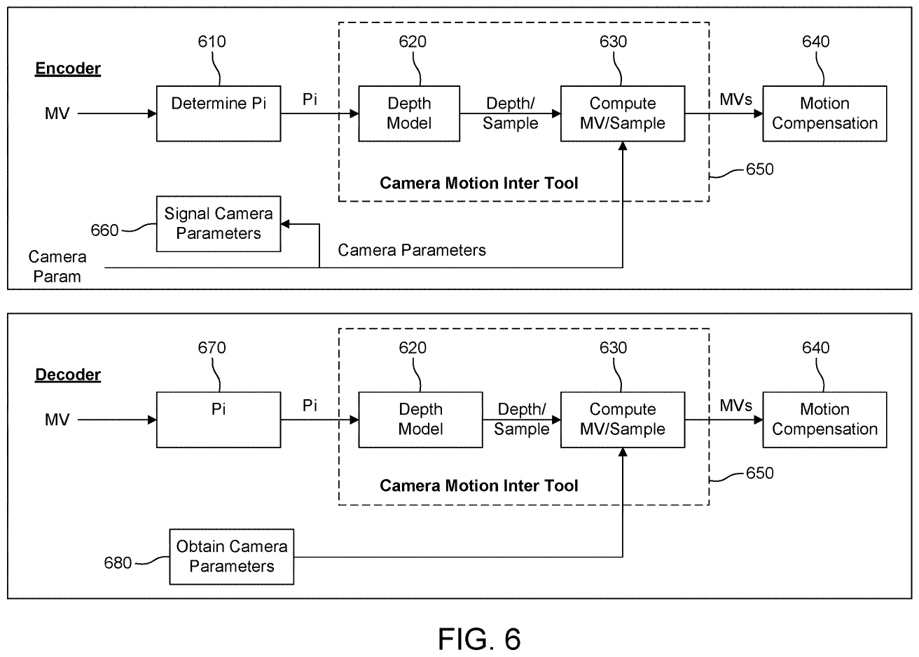

FIG. 6 illustrates a camera motion inter tool in a codec in which various aspects of the embodiments may be implemented. According to a salient feature, camera motion inter tool 650 approximates the depth of the CU to be compressed to a plane. Depending on the orientation of this plane in the 3D space, four different depth models can be used to approximate the plane, characterized by 1, 2 or 3 depth parameters Pi. These depth parameters do not represent the depth in the 3D scene, but a third coordinate representing the depth associated to the 2D image coordinates. Usually, this third coordinate may be obtained from the projection of a 3D point by the game engine's virtual camera. According to a salient feature of the at least one embodiment, this third coordinate may be obtained from the projection of a reconstructed 3D point, the 3D point being reconstructed from motion information, such as a motion vector and reference picture, associated with the 2D image sample. Thanks to the depth models, characterized by only few depth parameters i.e. a few motion vectors such as the motion vector of an already reconstructed sample, a depth information is available per pixel (or per 4×4 pixel blocs in VTM) in a camera motion coded block. This depth information, associated with the camera parameters, is used to compute a motion vector per sample. Then the motion compensation 640 can be performed, as it is performed in the state of art.

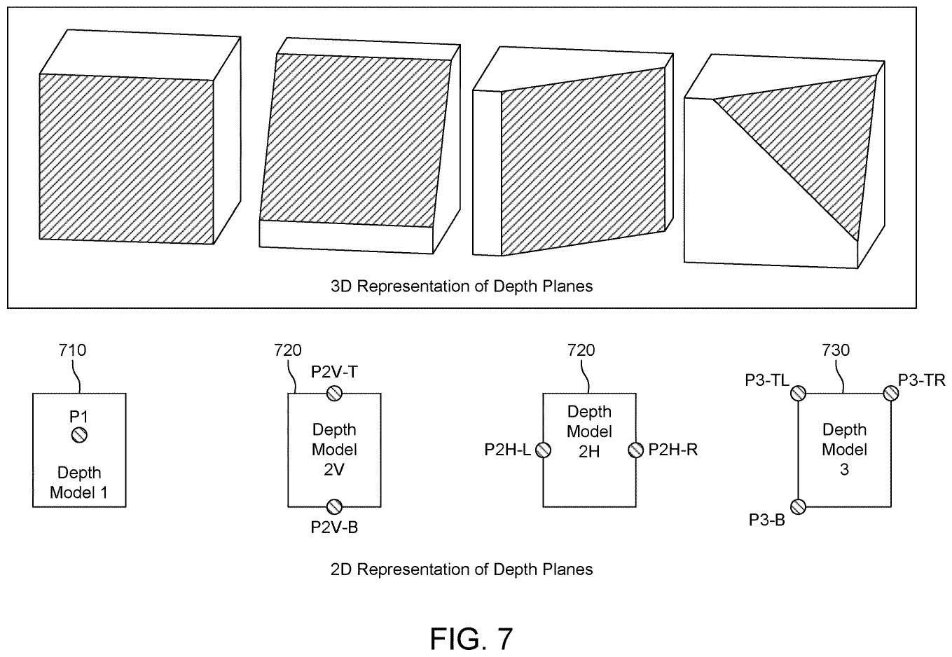

FIG. 7 illustrates 4 exemplary representations of a plane of a depth model. The hatched planes represent some planes in the 3D game scene which are only affected by the game engine's camera. Below these 3D hatched planes, an exemplary Camera Motion Coding Block (CB) 710, 720, 730 corresponding to the projection of a part of the hatched planes by the camera is represented.

According to a first variant, a depth model for the coding block includes a plane parallel to a camera's sensor and is characterized by one depth parameter. In this variant, the plane 710 of the coding block may be approximated by a plane parallel to the camera's sensor, the coding block is represented by only one depth parameter (Depth Model1). The depth parameter represents the depth value of the central sample P1 in the coding block, which is also the depth value of any sample in the coding block.

According to a second variant, a depth model for the coding block includes a plane 720 tilted vertically or horizontally with respect to a camera's sensor and the depth model is characterized by two depth parameters. In this variant, the plane may either be tilted horizontally (Depth Model 2H implying a horizontal depth interpolation) or vertically (Depth Model 2V implying a vertical depth interpolation). In this case, two depth parameters are required to define the depth plane. For instance, for the Depth Model 2V, a first depth parameter represents a depth value of a central sample P2V-T on a top border line of the coding block and a second depth parameter represents a depth value of a central sample P2V-B on a bottom border line of the coding block. For instance, for the Depth Model 2H, a first depth parameter represents a depth value of a central sample P2H-L on a left border line of the coding block and a second depth parameter represents a depth value of a central sample P2H-R on a right border line of the coding block. Then, the depth of any sample in the coding block is determined using an interpolation between the depth values indicated by the two depth parameters.

According to a third variant, a depth model for the coding block includes a plane tilted vertically and horizontally with respect to a camera's sensor and the depth model is characterized by three depth parameters. In the variant, the plane is tilted in both directions (Depth Model 3) and three parameters are required. For instance, for the Depth Model 3, the three parameters respectively represent the depth value of a top-left sample P3-TL of the coding block, a depth value of a top-right sample P3-TR of the coding block, a depth value of a bottom-left sample P3-B of the coding block. The skilled in the art will appreciate that the positions of samples used in the depth plane model are non-limiting examples, and that the present principles may contemplate any implementation of depth parameters allowing to define the 4 plane models. Back to FIG. 6, the new Camera Motion Inter tool consists in computing the motion vectors in a new way for contents such as game engine contents. The Camera Motion inter tool 650 is indicated by the dotted line in encoder and decoder scheme of FIG. 6. Firstly, for each sample of the block (or a sub-sampled set in the block, sub-sampling by 4 in both direction for instance), an estimate of the depth of a sample is computed 620 depending on its position, the Camera Motion Depth Model and its associated parameters, where the depth in the coding block is represented with a parametric plane. Secondly, a motion vector is computed 630 depending on the sample position, the estimate depth and the camera parameters. The block diagram of FIG. 6 partially represents modules of an encoder or encoding method, for instance implemented in the exemplary encoder of FIG. 2. The block diagram of FIG. 6 further partially represents modules of a decoder or decoding method, for instance implemented in the exemplary decoder of FIG. 3. The Camera Motion inter tool receives some depth model parameters Pi along with camera parameters and provides motion vectors MVs used to compute the motion compensation 640. The camera parameters represent the characteristics and the position of the game engine's virtual camera. They are provided for the reference image and for the current image to be encoded. In an embodiment, the encoder may determine 610 a depth parameter Pi for a depth model i by approximating the depth at the coding block position with a plane. Depending on the depth model, the coding block depth is approximated with a plane characterized by up to 3 parameters Pi. For instance, for the Depth Model1 representing a block with constant depth, a single depth parameter P1 may be obtained by taking one of the depth of the central pixel of the coding block, an average depth around the central pixel of the coding block, or the average depth of the coding block, with or without sub-sampling. Advantageously, the depth model for the coding block is determined from estimate depth values computed using motion information of a causal neighborhood.

Then, the encoder reconstructs 620 depth values of the coding block based on the depth model parameters Pi. It determines an estimation of the depth value of any sample of the coding blocks. A motion vector responsive to camera motion compensation per sample is computed depending on its position, its approximated depth, and the camera parameters.

Depending on the implementation, to reduce the complexity, a motion vector may be computed for a block of samples. For instance, a motion vector is computed per block of 4×4 samples. These motion vectors are then used to perform the motion compensation 640 as known by the skilled in the art. Since this vector is computed with the depth and the camera parameters, it represents the displacement of the current sample between the reference frame and the current frame due to a camera motion (translations and/or rotations), or a modification of the camera's characteristics (focal length, . . . ). Different motion predictors issued from the Camera motion inter tool may be put into competition into a RDO loop to determine the motion model along with associated parameters that result in the lower rate distortion cost.

Additionally, the encoder may further provide adequate signaling of the selected depth model to enable a decoder to recover 670 the parameters Pi to be used at the input of to the camera motion inter tool 650. According to at least one embodiment, the depth parameters Pi may be derived using motion information of causal neighborhood. Additionally, the encoder may further signal 660 camera parameters for the images.

On the decoder side, the Camera motion inter tool computes Camera Motion MVs as done in the encoder. To that end, the decoder obtains 670, for instance by processing some motion vectors as disclosed in the present application, the parameters Pi of the depth model of a coding block to decode. Additionally, the decoder obtains 680 camera parameters for the current image and for the reference image. The camera parameters for the reference image may be stored locally in the decoder at the reconstruction of the reference image.

In the following, at least one embodiment of the determining of depth information 610, 670 of the depth model for the camera motion inter tool are detailed. The input parameters Pi characterizing the depth model of the Camera Motion inter tool represent a depth information.

In the EP Application Serial No. 22306847.9, this depth information could be available at the encoder side, for instance when they are provided by a game engine as a depth map associated to the texture. But in this case, this information should also be transmitted to the decoded, implying an extra cost not acceptable in the scope of video compression. It is desirable to provide such parameters representing the depth to the Camera Motion tool while limiting extra cost due to the transmission of depth information to the decoder.

When compressing the current CU, some motion vectors provided by the already compressed neighboring CUs are available. They usually provide good motion vector candidates to compress the current CU. In a video codec, where no depth information is available. At least one embodiment relates to using some motion vectors, associated with the camera parameters, to estimate the depth parameters Pi characterizing the depth planes.

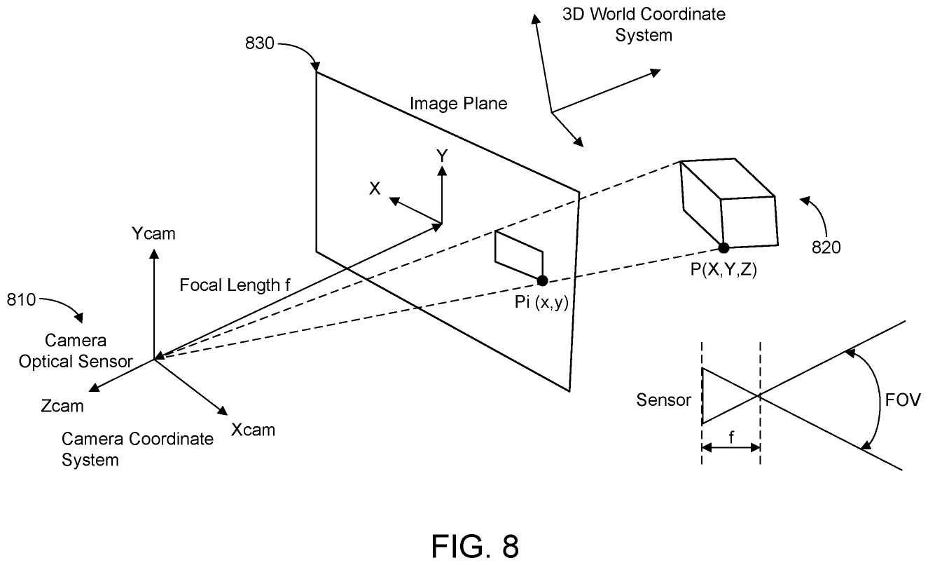

FIG. 8 illustrates principles of a pinhole camera model of a virtual camera in a cloud gaming system. The 3D engine uses a virtual camera 810 to project the 3D scene 820 onto a plane 830 to generate a 2D image. In the pinhole camera representation, the physical characteristics of the camera (focal length, sensor size, field of view, . . . ) may be used to compute a projection matrix, which is the intrinsic matrix of the camera. This matrix defines a point Pi(x,y) in the 2D image where a point P(X, Y, Z) in the 3D space is projected. In the following, the matrix is referred to as the camera projection matrix and the 2D image as a game engine 2D rendered image. A depth map is a representation of the depth of a point belonging to the 2D projected image. However, a depth value in the depth map does not directly represent the depth of a 3D point in the 3D scene. When a 3D point is projected to a 2D image, it is projected to an image position (x,y). Mathematically a third coordinate exists, however this third coordinate is dropped when considering depth in a 2D image, although it is stored in the game engine's Z buffer.

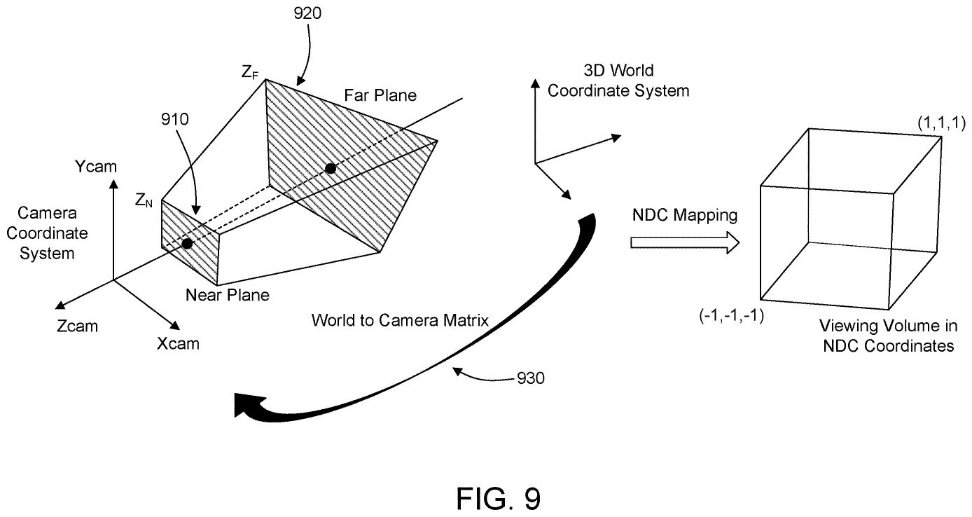

FIG. 9 illustrates projection planes of a virtual camera in a cloud gaming system. Indeed, unlike physical cameras that project objects distant from 0 to infinity, a virtual camera of a game engine projects the objects in between two projection planes: a near plane 910 and a far plane 920. It means that these two planes represent the minimal and maximal depth used for the rendering: the near plane 910 is usually mapped to depth 0 and the far plane 920 to depth 1. However, according to a variant, the depth value associated with the far and near plane may be represented conversely. The camera projection matrix depends on the position of the planes 910, 920. In a variant, the projection matrix remaps the 3D point's coordinates to a position in a Normalized Device Coordinate NDC space. In this case, the viewing volume is a cube, where the three coordinates are expressed in the range [−1,1]. The way this matrix is built is not described here, but well known in OpenGL or DirectX for instance. Besides, the camera projection matrix performs its projection relatively to its own coordinate system, the camera coordinate system as illustrated in FIG. 8 and FIG. 9. Since the camera is not placed at the origin of a 3D world coordinate system, another matrix is required to convert the position of a 3D point from the 3D world coordinate system to the camera coordinate system. The world to camera matrix 930 is utilized to represent the rotations and the translations of the camera relative to the 3D world coordinate system. The relationship between a 3D point in the game's 3D world and its 2D position in the 2D projected image is defined by the world to camera projection matrix 930 and the camera projection matrix. Conversely, the position of a 2D image point can be linked to a 3D world point by the inverse projection matrix and the camera to world matrix. To achieve the reconstruction of a 3D world point from the 2D projected image, a third image coordinate Zbuff representing the depth value, here an approximated depth value computed from motion information of previously reconstructed samples, may be used for each sample of 2D projected image.

At least one of the present embodiments generally relates to a method or an apparatus for video encoding or decoding, and more particularly, to a method or an apparatus comprising determining motion information representative of camera motion. According to a salient characteristic, at least one depth parameter of a depth model is determined based on a motion vector associated with the current sample, the motion vector being representative of the motion information of the current sample between a reference image and a current image.

Advantageously, the depth model, which include a plane representative of depth values of at least one sample in the current image, is used to determine motion information representative of camera motion between the current image and the reference image.

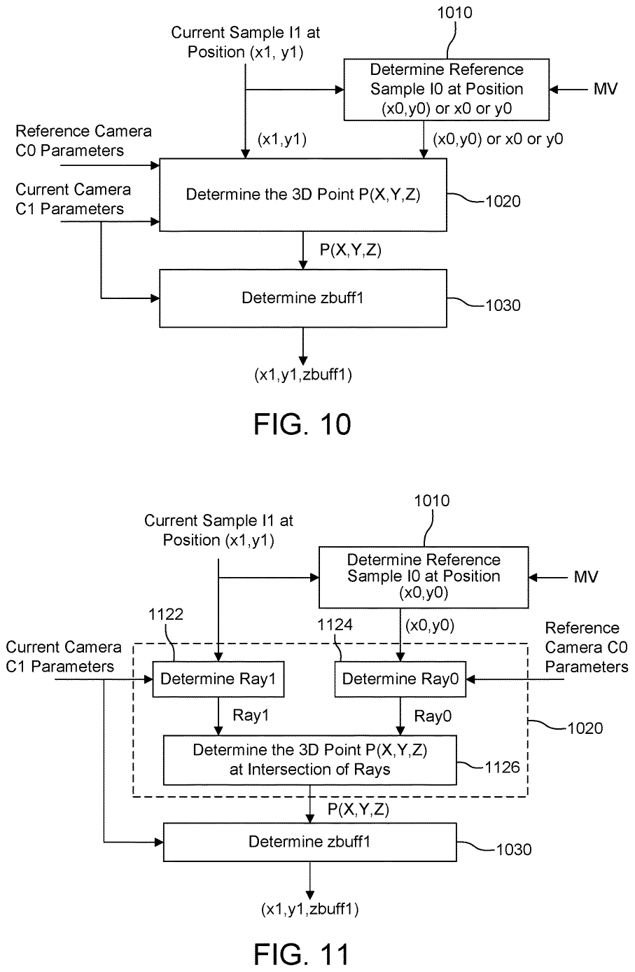

FIG. 10 illustrates a generic method according to a general aspect of at least one embodiment. The block diagram of FIG. 10 partially represents modules of an encoder or encoding method, for instance implemented in the exemplary encoder of FIG. 2 or of FIG. 6 (within the module 610). The block diagram of FIG. 10 further partially represents modules of a decoder or decoding method, for instance implemented in the exemplary decoder of FIG. 3 or of FIG. 6 (within the module 670). FIG. 10 illustrates an exemplary method to determine a depth parameter zbuff1 from a motion vector MV associated to a current sample I1 at a 2D position (x1, y1) in the current image and from the camera parameters C1 and C0 associated to the current image and reference image. In a preliminary step, not shown here, a position (x1, y1) of the current sample I1 as well as associated motion vector MV representative of the motion of the sample between a reference image and a current image are obtained. According to a first variant embodiment, the motion vector MV comprises 2 components for the 2 dimensions of the image. According to a second variant embodiment, the motion vector MV may comprise only one component for any of the horizontal dimension or the vertical dimension of the image. In a step 1010, a position of the current sample in a reference image is determined based on the motion vector for the current sample and the position of the current sample I1(x1, y1) in the current image. According to the first or second variant, the position of the current sample 10 in a reference image comprises 2 components (x0, y0) or only one of the components x0 or y0. The determination 1010 of a position of the current sample in a reference image is further detailed hereafter in the exemplary embodiments of the first and second variant. In a step 1020, a position P(X, Y, Z) of a 3D point is determined where the 3D point corresponds to the current sample in the 3D space. The determination 1020 of the 3D point position is also further detailed hereafter in the exemplary embodiments of the first and second variant. The determination is based on both the position of the current sample in the current image and in the reference image and based on camera parameters for the current image and for the reference image. In the first variant using the 2 dimensional components of the motion vector, the 3D point corresponding to the current sample in the 2D space is determined as being at an intersection of 2 lines or rays. In the second variant using only one of the dimensional components of the motion vector, the 3D point corresponding to the current sample is determined as being an intersection of a line (ray) and a plane. Then, in a step 1030, the 3D point P(X, Y, Z) is projected according to the current camera domain, as defined by the world to camera matrix and the camera projection matrix, to determine the Z buffer value associated to the current sample. Advantageously, the Z buffer value is the depth value of the current sample in the current image. The reconstructed depth value may be used as at least one depth parameter of a depth model of the camera Motion inter tool where the depth model includes a plane representative of depth values of at least one sample in the current image.

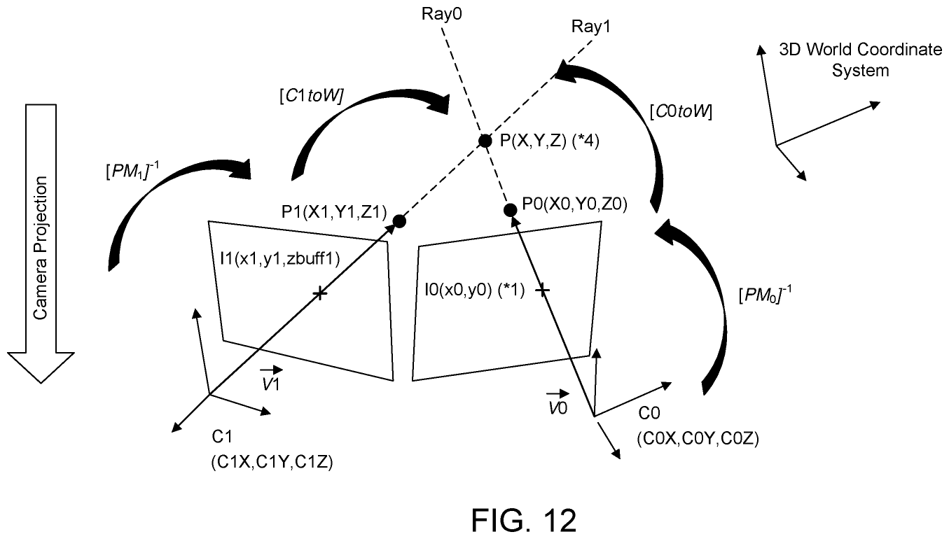

FIG. 11 illustrates a generic method according to a first variant embodiment with 2 components motion vector. The current sample I1(x1,y1) in the current image is associated with the sample I0 (x0,y0) in the reference image by the motion vector MV having coordinates (MV.x, MV.y). It means that the 3D point P(X, Y, Z) in the 3D scene, is represented by I1(x1,y1) in the current image and by I0(x0,y0) in the reference image. According to ray tracing principle, this 3D point P(X, Y, Z) corresponds to the intersection of 2 rays which respectively represents the direction of the projection of the 3D point into the current or refence image from the camera position. The first ray or line passes at position I1(x1,y1) and has its origin at the position of the current camera C1. The second ray or line passes at position I0 (x0,y0) and has its origin at the position of the reference camera C0. These 2 lines are called Ray1 and Ray0 in FIG. 12. From the reconstructed 3D point P(X, Y, Z) position, the camera projection according to the current camera C1 is applied to reconstructed 3D point P(X, Y, Z) and allows to obtain the Z buffer value zbuff1 associated to the 2D sample I1(x1,y1).

FIG. 12 illustrates 2D to 3D deprojections according to a first variant embodiment with a 2 components motion vector. The camera C1 represents the camera capturing the current image I1, and the camera C0 to the camera capturing the reference image 10. Both are characterized by their camera parameters, defining their characteristics and their position (intrinsic and extrinsic matrices). As shown in FIG. 12, 4 matrices [PM1]⁻¹, [C₁toW], [PM₀]⁻¹, [C₀toW], representative of a change of coordinate system or projection/deprojection are used to compute transformation between a 3D point and a corresponding sample in a current image. The matrices are 4x4. The camera to world matrix [C₀toW] and the inverse projection matrix [PM₀]⁻¹ characterize the camera and its position with respect to the reference image I0. The camera to world matrix [C₁toW] and the inverse projection matrix [PM₁]⁻¹ corresponds to camera in the current image I1. The zbuf1 information representing the depth of the current sample I1 is determined as follows. In this first variant, the sample position I0(x0,y0) in the reference image is determined in a step 1010 based on the motion vector MV associated with the current sample position I1(x1,y1) according to state of the art motion compensation.

$${x}_{0} = {x}_{1} + MV \cdot x$$

$${y}_{0} = {y}_{1} + MV \cdot y$$

With MV.x and MV.y being the 2 components of the motion vector in the horizontal and vertical dimension. Associated with the camera parameters, the current and reference positions I0 and I1 may be used to determine the position of the 3D point P(X, Y, Z) in the 3D scene as the intersection of two rays. In the game engine use case of FIG. 5, the camera parameters represent the characteristics and the position of the game engine's virtual camera. C0 corresponds to camera parameters of a camera capturing the reference image while C1 corresponds to camera parameters of a camera capturing the current image. In the following, reference to camera parameters C or camera C may be used indifferently. The first ray Ray1 starts at the origin of the current camera C1 and passes through the 3D point P(X, Y, Z). Any 3D point P1 on the ray may be rendered on the 2D image at current sample position I1(x1,y1). The second ray Ray0 starts at the origin of the reference camera C0 and passes through the 3D point P(X, Y,Z). Any 3D point P0 on the ray may be rendered on the 2D image at the reference sample position I0. A ray may be characterized by its origin, and a direction provided by a vector, referred to as ray vector herein to avoid any confusion with the motion vector. The origin of the rays corresponds to the origin of the cameras C0 (COX, COY, COZ) and C1 (C1X,C1Y,C1Z). These positions are available in the camera to world matrices, the fourth column representing the translation vector of the camera relatively to the 3D world origin. The ray vectors may be obtained by determining the position of any 3D point P1 and P0 as shown in FIG. 12, whose image is rendered at the 2D image sample location (x1,y1) and (x0,y0).

As such P1 corresponds to a deprojection of the image point I1(x1, y1, z_any) having any depth value z_any. In a step 1124 in FIG. 11, the ray Ray0 is determined in the reference camera domain. First, we have to perform the de-projection of I0 (x0,y0) to obtain the 3D point P0 (X0, Y0,Z0). The 2D image sample I0 (x0,y0) is expressed in Normalized Device Coordinates (NDC), in the range [−1,1]. The center of the image being [0, 0], the third coordinate z_any is arbitrarily set to 1, corresponding to the far plane as shown on FIG. 9.

$${I}_{0} = {[ {x}_{0} , {y}_{0} , 1 , 1 ]}^{T}$$

We first perform a de-projection, by applying the inverse projection matrix [PM₀]⁻¹ of the camera C0:

$${[ {x}_{cam 0} , {y}_{cam 0} , {z}_{cam 0} , {w}_{cam 0} ]}^{T} = {[ {PM}_{0} ]}^{- 1} * {[ {x}_{0} , {y}_{0} , 1 , 1 ]}^{T}$$

To represent a real 3D cartesian point, the fourth coordinate W_{cam0} should be equal to 1, therefore the four coordinates are divided by W_{cam0}.

$${[ {x}_{cam 0}^{′} , {y}_{cam 0}^{′} , {z}_{cam 0}^{′} , {w}_{cam 0}^{′} = 1 ]}^{T} = {[ \frac{{x}_{cam 0}}{{w}_{cam 0}} , \frac{{y}_{cam 0}}{{w}_{cam 0}} , \frac{{z}_{cam 0}}{{w}_{cam 0}} , \frac{{w}_{cam 0}}{{w}_{cam 0}} ]}^{T}$$

By applying the camera to world matrix [C₀toW], the following 3D point [x0, Y0, Z0, W0=1]^{T} represents the de-projection of I₀=[x₀, y₀, 1,1]^{T}, according to the C0 camera domain.

$$P 0 = {[ X 0 , Y 0 , Z 0 , W 0 = 1 ]}^{T} = [ {C}_{0} to W ] * {[ {x}_{cam 0}^{′} , {y}_{cam 0}^{′} , {z}_{cam 0}^{′} , {w}_{cam 0}^{′} = 1 ]}^{T}$$

Then, the ray vector V0 is defined as the vector passing from the two points P0 and C0.

$$\vec{V 0} = P 0 - C 0$$

The expression of the ray Ray0 in reference camera domain is:

$$Ray 0 = C 0 + {k}_{0} \vec{V 0}$$

In a step 1122 in FIG. 11, the ray vector V1 may be determined in the same way according to the C1 camera domain. The current image ray is represented by Ray1=C1+K₁V̅1̅. The position of the 3D point P(X, Y, Z) corresponds to the intersection of these two rays and is modelized by

$$P = C 0 + {k}_{0} \vec{V 0} = C 1 + {k}_{1} \vec{V 1}$$

The two scaling coefficients k₀ and k₁ may be determined with the two following equations:

$$\{ \begin{matrix}C 0 X + {k}_{0} {V 0}_{x} = C 1 X + {k}_{1} {V 1}_{x} \\ C 0 Y + {k}_{0} {V 0}_{y} = C 1 Y + {k}_{1} {V 1}_{y}\end{matrix}$$

$$⇒ {k}_{1} = \frac{V {0}_{x} ( C 0 Y - C 1 Y ) + V {0}_{y} ( C 1 X - C 0 X )}{V {1}_{y} V {0}_{x} - V {0}_{y} V {1}_{x}}$$

### Alternatively:

$$⇒ {k}_{0} = \frac{{V 1}_{x} ( C 0 Y - C 1 Y ) + {V 1}_{y} ( C 1 X - C 0 X )}{V {1}_{y} V {0}_{x} - V {0}_{y} V {1}_{x}}$$

Then, in a step 1030, the 3D point P(X, Y, Z) is used to compute the third component Zbuff1 of the sample I1, by applying a projection according to the C1 camera domain.

The world to camera C1 matrix [WtoC1] is applied, followed by the Projection Matrix [PM₁]:

$${[ {x}_{cam 1} , {y}_{cam 1} , {z}_{cam 1} , {w}_{cam 1} = 1 ]}^{T} = [ W to C 1 ] * {[ X , Z , Y , W = 1 ]}^{T}$$

$${[ {x}_{1}^{′} , {y}_{1}^{′} , {z}_{1}^{′} , {w}_{1}^{′} , ]}^{T} = [ {PM}_{1} ] * {[ {x}_{cam 1} , {y}_{cam 1} , {z}_{cam 1} , {w}_{cam 1} = 1 ]}^{T}$$

Then the fourth coordinate w should be normalized to obtain the image point P1(x1, y1, zbuff1):

$${[ {x}_{1} , {y}_{1} , {zbuff}_{1} , {{w}_{1}}_{{=}^{}} 1 ]}^{T} = {[ \frac{{x}_{1}^{′}}{{w}_{1}^{′}} , \frac{{y}_{1}^{′}}{{w}_{1}^{′}} , \frac{{z}_{1}^{′}}{{w}_{1}^{′}} , \frac{{w}_{1}^{′}}{{w}_{1}^{′}} ]}^{T}$$

The Zbuff1 value represents the depth, as it would have been provided by the game engine in its Z buffer for the current sample I1(x1,y1). This depth value may be used as a Depth Model parameter Pi, as presented in FIG. 6 and this depth value does not have to be transmitted to the decoder since it can be computed at the decoder side from a motion vector.

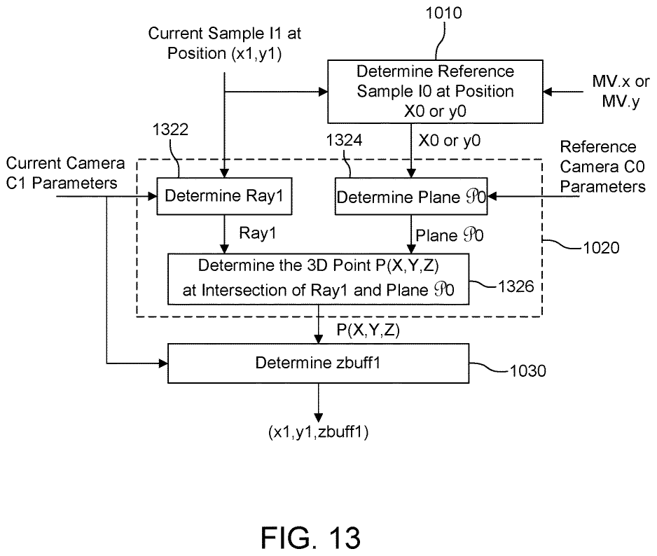

FIG. 13 illustrates a generic method according to a second variant embodiment with a single component motion vector. The sample I1(x1,y1) in the current image is associated with a sample located along an horizontal position x0 or a vertical position y0 in the reference image. The reference sample horizontal position x0 may be computed 1010 with only the horizontal component of the motion vector. The reference sample vertical position y0 may be computed 1010 with only the vertical component of the motion vector.

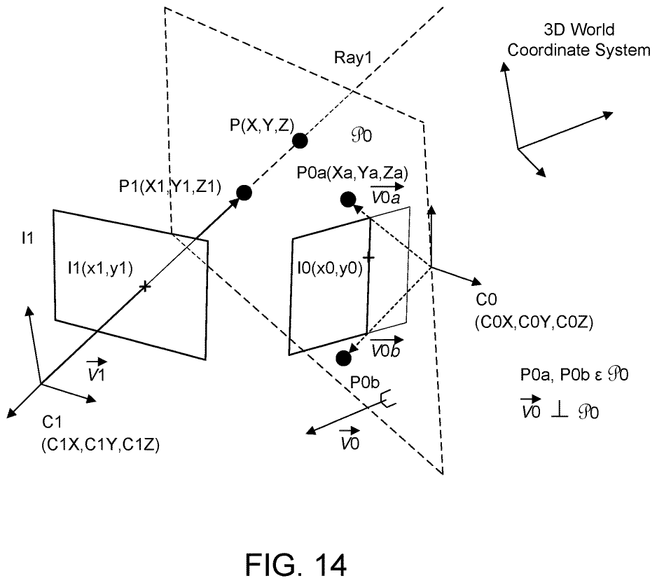

FIG. 14 illustrates 2D to 3D deprojections according to the second variant embodiment with a single component motion vector where only the horizontal component of the motion vector is used. The 3D point P(X, Y, Z) represented by the sample I1(x1,y1) corresponds to the intersection of a plane and a line Ray1. The first line Ray1 starts at the origin of the current camera C1 and passes through the 3D point P(X, Y, Z). Any 3D point P1 on the ray Ray1 may be rendered on the 2D image at current sample position I1(x1,y1). When considering only the horizontal component of the motion vector, the plane P0 is a vertical plane passing at the position of the reference camera C0, but also through the 3D point P, and which is such that any 3D point in the plane P0 is projected at a point having horizontal position x0 in the reference image. According to a variant where only the vertical component of the motion vector is used, this plane is a horizonal plane passing at the position of the reference camera, and which is such that any 3D point in the plane is projected at a point having a vertical position y0 in the reference image. Back to FIG. 13, in a step 1030, the 3D point P(X, Y, Z) is projected in the 2D space of the current image using the camera projection to obtain the Z buffer value zbuff1 associated with the 2D sample I1(x1,y1). The camera C1 represents the camera corresponding to the current image I1, and the camera C0 the camera of the reference image 10. Both cameras are characterized by their camera parameters, defining their characteristics and their position (intrinsic and extrinsic matrices). In a step 1324, the plane P0 is determined. From the horizontal component MV.x of the motion vector MV associated with the current sample position (x1,y1), the horizontal sample position x0 in the reference image is determined

$${x}_{0} = {x}_{1} + MV \cdot x$$

In this variant, the vertical position y0 in the reference image is not known. However, the 3D point P(X, Y, Z) is represented by the sample 10 in the reference image and P(X, Y, Z) belongs to the plane P0 that is projected at the horizontal position x0 and passes at the position of the reference camera C0. Besides, the 3D point P(X, Y, Z) is also represented by the sample 11 (x1,y1) in the current image and therefore P(X, Y,Z) is on the Ray1. This ray Ray1 starts at the origin of the current camera C1 and a 3D point P1 that is a de-projection of the current sample I1 having any depth value. The ray Ray1 may be characterized by its origin, and its direction provided by a vector (called ray vector below, to avoid any confusion with the motion vector). The origin of the ray corresponds to the origin of the cameras C1 (C1X,C1Y,C1Z). This position is available in the camera to world current matrix [C₁toW], the fourth column representing the translation vector of the camera relatively to the 3D world origin. The ray vector may be obtained by determining the position of any 3D point P1 whose image is rendered at the 2D image sample location (x1,y1). To that end, first, the ray Ray1 is determined 1322 according to the current camera domain. In other word, a de-projection [PM₁]⁻¹ is applied to I1(x1,y1) to obtain a 3D point P1 (X1,Y1,Z1). The 2D image sample I1(x1,y1) should be expressed in Normalized Device Coordinates (NDC), in the range [−1,1]. The center of the image being [0, 0]; The third coordinate is arbitrarily set to 1, for instance corresponding to the far plane of FIG. 9.

$${I}_{1} = {[ {x}_{1} , {y}_{1} , 1 , 1 ]}^{T}$$

A de-projection is performed by applying the inverse projection matrix [PM₁]⁻¹ of the camera C1 to the 2D image sample I1:

$${[ {x}_{cam 1} , {y}_{cam 1} , {z}_{cam 1} , {w}_{cam 1} ]}^{T} = {[ {PM}_{1} ]}^{- 1} * {[ {x}_{1} , {y}_{1} , 1 , 1 ]}^{T}$$

To represent a real 3D cartesian point, the fourth coordinate W_{cam0} should be equal to 1. The four coordinates should be normalized by a division by W_{cam0}.

$${[ {x}_{cam 1}^{′} , {y}_{cam 1}^{′} , {z}_{cam 1}^{′} , {w}_{cam 1}^{′} = 1 ]}^{T} = {[ \frac{{x}_{cam 1}}{{w}_{cam 1}} , \frac{{y}_{cam 1}}{{w}_{cam 1}} , \frac{{z}_{cam 1}}{{w}_{cam 1}} , \frac{{w}_{cam 1}}{{w}_{cam 1}} ]}^{T}$$

By applying the camera to world matrix [C₁toW], the following 3D point [X1, Y1, Z1, W1=1]^{T} represents the de-projection of I₁=[x₁, y₁, 1,1]^{T}, according to the C1 camera domain.

$$P 1 = {[ X 1 , Y 1 , Z 1 , W 1 = 1 ]}^{T} = [ {C}_{1} toW ] * {[ {x}_{cam 1}^{′} , {y}_{cam 1}^{′} , {z}_{cam 1}^{′} , {w}_{cam 1} = 1 ]}^{T}$$

Thus, the ray vector V1 is defined as the vector passing from the two points P1 and C1.

$$\vec{V 1} = P 1 - C 1$$

The 3D point P(X, Y,Z) is somewhere on the Ray1. It means that P(X, Y,Z) may be expressed by:

$$P = C 1 + k \vec{V 1}$$

The coefficient k is not known. But since P(X, Y,Z) also belongs to the plane P0, k may be determined in 1326 with the equation defining the plane P0. The plane P0 may be defined by the following plane equation, where X, Y, Z represent the 3D coordinates.

$$a \cdot X + b \cdot Y + c \cdot Z + d = 0$$

The 3 coefficients a, b and c are the 3 components of a vector \vec{V0} perpendicular to the plane in the 3D space.

$$\vec{V 0} = {[ a , b , c ]}^{T}$$

This vector \vec{V0} may be obtained by the cross product of 2 non colinear vectors \vec{V0α} and \vec{V0b} in the plane. These 2 vectors may be chosen arbitrary in the plane as shown on FIG. 14. Advantageously, in the variant where these 2 vectors are perpendicular, the result is more accurate. The vector \vec{V0a} is determined by considering the 3D point \vec{P0a}, and the vector \vec{V0b} is determined by considering the 3D point P0b, both in the plane P0:

$$\vec{V 0} = {[ a , b , c ]}^{T} = \vec{V 0 a} ∧ \vec{V 0 b}$$

For instance, the 3D point P0a is the de-projection of the image sample p₀_{ₐ}=[x₀, focal_{y}, 1,1]^{T}, and P0b is the de-projection of the image sample p_{0b}=[x₀,−focal_{y}, 1,1]^{T}. The focal parameter being provided by the intrinsic matrix of the reference camera.

As described above with the determining 1322 of the ray₁, a de-projection is applied to obtain a 3D point P1 from a 2D sample. The de-projection comprises expressing the 2D sample in Normalized Device Coordinates (NDC), in the range [−1,1]; applying the inverse projection matrix [PM₀]⁻¹; dividing the 4 four coordinates by w (the fourth coordinate) to obtain a cartesian point in the 3D space; and applying the camera to world matrix [C₀toW] to the previous result. The 2 vectors in the planes are:

$$\vec{V 0 a} = P 0 a - C 0$$

$$\vec{V 0 b} = P 0 b - C 0$$

The vector product of \vec{V0a} and \vec{V0b} provides the coefficients a, b and c. In the plane equation, the constant coefficient d may be computed by arbitrary taking a point in the plane. We can for instance take the 3D point P0a(Xa, Ya,Za) to obtain d:

$$d = - ( a \cdot Xa + b \cdot Ya + c \cdot Za )$$

Now, the equation a.X+b.Y+c.Z+d=0 of the plane P0 is known and as the 3D point P=C1+k\vec{V1} belongs to the plane, the k parameters may be determined according to the following equations:

$$a \cdot ( C 1 x + k \cdot V 1 x ) + b \cdot ( C 1 y + k \cdot V 1 y ) + c \cdot ( C 1 z + k \cdot V 1 z ) + d = 0 \text{=>} k = - \frac{a \cdot C 1 x + b \cdot C 1 y + c \cdot C 1 z + d}{a \cdot V 1 x + b \cdot V 1 y + c \cdot V 1 z}$$

At the output of 1326, the 3D point P(X, Y,Z) on the ray Ray1 and belonging to the plane P0 is known. The third component Zbuff1 of the sample I1 is determined in 1030 by applying a projection according to the world C1 camera domain [WtoC1]. The world to camera matrix [WtoC1] is applied, followed by the camara projection matrix [PM₁]:

$${[ {x}_{cam 1} , {y}_{cam 1} , {z}_{cam 1} , {w}_{cam 1} = 1 ]}^{T} = [ WtoC 1 ] * {[ X , Z , Y , W = 1 ]}^{T}$$

$${[ {x}_{1}^{′} , {y}_{1}^{′} , {z}_{1}^{′} , {w}_{1}^{′} ]}^{T} = [ {PM}_{1} ] * {[ {x}_{cam 1} , {y}_{cam 1} , {z}_{cam 1} , {w}_{cam 1} = 1 ]}^{T}$$

Then the fourth coordinate w should be normalized to obtain the image point P1(x1, y1, zbuff1):

$${[ {x}_{1} , {y}_{1} , {zbuff}_{1} , {w}_{1} = 1 ]}^{T} = {[ \frac{{x}_{1}^{′}}{{w}_{1}^{′}} , \frac{{y}_{1}^{′}}{{w}_{1}^{′}} , \frac{{z}_{1}^{′}}{{w}_{1}^{′}} , \frac{{w}_{1}^{′}}{{w}_{1}^{′}} ]}^{T}$$

The Zbuff1 value represents a predictor of the depth, as it would have been provided by the game engine in its Z buffer, for the current sample I1(x1,y1) considering only one motion vector component. This second variant embodiment describes how a depth parameter can be computed when considering only the horizontal component of the motion vector. The skilled in the art will directly and non-ambiguously be able to derive another variant considering only the vertical component of the motion vector, the plane P0 is an horizontal plane, passing at the vertical position y0 of the reference frame and at the reference camera position. Advantageously, when implemented in a codec, a motion vector may provide 2 depth predictors while considering separately the 2 components of a motion vector. At the encoding, a Rate-Distortion cost may be applied to select the depth parameter predictor providing the best compression performance for the Camera Motion inter tool. Thanks to the camera parameters, this predicted depth parameter can be used as a Depth Model parameter Pi, as presented in FIG. 6. Advantageously, the depth model parameter Pi used in a Camera Motion inter compensation does not have to be transmitted to the decoder since it can be computed at the decoder side.

### Additional Embodiments and Information

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the inter prediction modules (270, 275, 375), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented as various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
SDP (session description protocol), a format for describing multimedia communication sessions for the purposes of session announcement and session invitation, for example as described in RFCs and used in conjunction with RTP (Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation;
RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
obtaining a position of a current sample in a current image;
determining a position of a reference sample in a reference image using a motion vector for the current sample and the position of the current sample in the current image;
determining a position of a 3D point corresponding to the current sample in the current image based on the position of the current sample in the current image and in the reference image and based on camera parameters for the current image and for the reference image;
determining a depth value for the current sample in the current image by projecting the 3D point, wherein the depth value is used as at least one depth parameter of a depth model, the depth model including a plane representative of depth values of at least one sample in the current image; and the depth model being used to determine motion information representative of camera motion between the current image and the reference image.

2. The method of claim 1, wherein determining the position of the 3D point corresponding to the current sample in the current image further comprises:
determining a first line passing through a camera position specified by the camera parameters for the current image and the position of a first 3D point corresponding to a de-projection of the current sample in the current image;
determining a second line passing through a camera position specified by the camera parameters for the reference image and a position of a second 3D point corresponding to a de-projection of a reference sample in the reference image; and
determining the position of the 3D point as an intersection of the first line and the second line.

3. The method of claim 2, wherein determining the position of the 3D point corresponding to the current sample in the current image further comprises:
determining the position of the first 3D point corresponding to a de-projection of the current sample in the current image by applying a 2D to 3D transformation specified by the camera parameters for the current image to the position of the current sample in the current image;
determining the position of the second 3D point corresponding to a de-projection of a reference sample in the reference image by applying a 2D to 3D transformation specified by the camera parameters for the reference image to the position of the reference sample in the reference image.

4. The method of claim 1, wherein determining the position of the 3D point corresponding to the current sample in the current image further comprises:
determining a line passing through a camera position specified by the camera parameters for the current image and through a position of a first 3D point corresponding to a de-projection of the current sample in the current image;
determining a vertical plane passing through a camera position specified by the camera parameters for the reference image wherein any 3D point in the vertical plane is projected at a sample having a horizontal position of the reference sample in the reference image;
determining the position of the 3D point as an intersection of the line and the vertical plane.

5. The method of claim 4, wherein determining the position of the 3D point corresponding to the current sample in the current image further comprises:
determining the position of the first 3D point corresponding to a de-projection of the current sample in the current image by applying a 2D to 3D transformation specified by the camera parameters for the current image to the position of the current sample in the current image;
determining the position of two 3D points respectively corresponding to a de-projection of a sample in the reference image having a same horizontal position as the reference sample, a 2D to 3D transformation specified by the camera parameters for the reference image being applied to the sample in the reference image having the same horizontal position as the reference sample in the reference image.

6. The method of claim 1, wherein determining the position of the 3D point corresponding to the current sample in the current image further comprises:
determining a first line passing through a camera position specified by the camera parameters for the current image and a position of a first 3D point corresponding to a de-projection of the current sample in the current image;
determining a horizontal plane passing through a camera position specified by the camera parameters for the reference image wherein any 3D point in the horizontal plane is projected at a sample having the horizontal position of the reference sample in the reference image; and
determining the position of 3D point as an intersection of the line and the horizontal plane.

7. The method of claim 6, wherein determining a 3D point position corresponding to the current sample in the current image further comprises:
determining the position of first 3D point corresponding to a de-projection of the current sample in the current image by applying a 2D to 3D transformation specified by the camera parameters for the current image to the position the current sample in the current image; and
determining the position of two 3D points respectively corresponding to a de-projection of a sample in the reference image having a same horizontal position as the reference sample, a 2D to 3D transformation specified by the camera parameters for the reference image being applied to the sample in the reference image having the same horizontal position as the reference sample in the reference image.

8. The method of claim 1, wherein the camera parameters are representative of a position and characteristics of a game engine virtual camera capturing an image of a game engine 2D rendered video.

9. A method, comprising:
obtaining a coding block in a current image, where the current image is part of a game engine 2D rendered video;
obtaining at least one parameter of a depth model for the coding block according to claim 1, where the depth model includes a plane representative of depth values;
determining motion information for at least one sample in the coding block of the current image to be coded in inter with respect to the reference image, where motion information is determined from the depth model for the coding block and the camera parameters, and motion information is representative of camera motion between the current image and the reference image; and
encoding the coding block based on the motion information.

10. The method of claim 9, wherein obtaining at least one parameter of a depth model for the coding block further comprises applying a rate distortion optimization on the encoding.

11. A method, comprising:
obtaining a coding block in a current image, where the current image is part of a game engine 2D rendered video;
obtaining at least one parameter of a depth model for the coding block according to claim 1, where the depth model includes a plane representative of depth values;
determining motion information for at least one sample in the coding block of the current image coded in inter with respect to a reference image, where motion information is determined from the depth model for the coding block and the camera parameters, and where motion information is representative of camera motion between the current image and the reference image; and
decoding the coding block based on the motion information.

12-15. (canceled)

16. The method of claim 1, wherein the current sample belongs to a coding block in the current image, the method further comprising performing block-based motion compensation on samples within the coding block using derived motion information in combination with conventional motion vectors.

17. An apparatus comprising a memory and one or more processors, wherein the one or more processors are configured to:
obtain a coding block in a current image, where the current image is part of a game engine 2D rendered video;
obtain at least one parameter of a depth model for the coding block, where the depth model includes a plane representative of depth values;
determine motion information for at least one sample in the coding block of the current image to be coded in inter with respect to the reference image, where motion information is determined from the depth model for the coding block and the camera parameters, and motion information is representative of camera motion between the current image and the reference image; and
encode the coding block based on the motion information.

18. The apparatus of claim 17, wherein the one or more processors being configured to obtain at least one parameter of a depth model for the coding block comprises the one or more processors being configured to obtain at least one parameter of a depth model for the coding block according to claim 1.

19. An apparatus comprising a memory and one or more processors, wherein the one or more processors are configured to:
obtain a coding block in a current image, where the current image is part of a game engine 2D rendered video;
obtain at least one parameter of a depth model for the coding block, where the depth model includes a plane representative of depth values;
determine motion information for at least one sample in the coding block of the current image coded in inter with respect to a reference image, where motion information is determined from the depth model for the coding block and the camera parameters, and where motion information is representative of camera motion between the current image and the reference image; and
decode the coding block based on the motion information.

20. The apparatus of claim 19, wherein the one or more processors being configured to obtain at least one parameter of a depth model for the coding block comprises the one or more processors being configured to obtain at least one parameter of a depth model for the coding block according to claim 1.
